(19) United States
(12) Patent Application Publication
(10) Pub. No.: US 2007/0061276 A1
(43) Pub. Date: Mar. 15, 2007

(54) Device and method for registering a plurality of types of information

(76) Inventors: Akira Sato, Kawasaki (JP); Seishi Okamoto, Kawasaki (JP); Hiroya Inakoshi, Kawasaki (JP); Takahisa Ando, Kawasaki (JP)

Correspondence Address: STAAS & HALSEY LLP, SUITE 700, 1201 NEW YORK AVENUE, N.W., WASHINGTON, DC, 20005, US

(21) Appl. No.: 10/595,030

(22) PCT Filed: Jul. 10, 2003
(86) PCT No.: PCT/JP03/08768

§ 371 Date: Dec. 30, 2005

(51) Int. Cl. G06F 17/30

(52) U.S. Cl. 707/1

(57) ABSTRACT

A common registration area for registering a plurality of types of information as unclassified information not classified for each category is displayed on a screen, and when a user performs an operation of registering arbitrary information in the registration area, specified information is registered as the unclassified information.

### CROSS REFERENCE TO RELATED APPLICATION

This application is a continuation of International PCT Application No. PCT/JP2003/008768 which was filed on Jul. 10, 2003.

### BACKGROUND OF THE INVENTION

1. Field of the Invention

The present invention relates to a device for registering a plurality of types of information and a method thereof, and is applicable to a content management technology and an information acquisition method.

2. Description of the Related Art

A content management system stores a variety of actual contents or location information on the Internet, an intra-net or a local computer in a storage device, such as a database or the like, manages them and enables them to be re-used. The contents include all types of information ranging from text to Web contents, a portable document format (PDF) document and an extensible markup language (XML) document.

The conventional content management system is focused on an area, such as the storage/management of files, multimedia, electronic mail, the retrieval of contents, the content classification of a joint project and content distribution corresponding to mobile products, and a variety of functions are provided (for example, see Non-patent references 1, 2 and 3).

Non-Patent Reference 1:

“Enterprise Content Management (ECM)”, [online], IBM Japan-Products and Services-Software for Corporations-Content Management-What's Enterprise Content Management (ECM), [retrieved Jun. 5, 2003], Internet<URL:http://www-6.ibm.com/jp/software/data/cm/ecm/>

Non-Patent Reference 2:

“Package Solution”, [online], documentum-Package Solution, [retrieved Jun. 5, 2003], Internet<URL:http://www.documentum.com.jp/solution/content-management_solutions.html>

Non-Patent Reference 3:

“Interstage Contentwiz V5 Introduction”, [online], Interstage-Download-Introduction Reference-Integration-Interstage Contentwiz V5 Introduction, [retrieved Jun. 5, 2003], Internet<URL:http://interstage.fujitsu.com/jp/v5/download/introduce/contentwiz_v5.pdf>

As more familiar applications, the content management also includes a function to categorize the location of resources and manage them, such as a bookmark or the like, mounted on Internet browsers, the site management function of local sites and the like. The site management function also includes a function to locate a page or data linked with nowhere, a function to check the size of a site or the like as a list, a function to automatically select and transfer only added/modified files, a function to retrieve/delete unnecessary files on a server and the like.

Furthermore, the content management function is also mounted on an application provided with a content distribution service function. The item “content management” also often appears in Web application development software and portal building software. In this way, the content management function is the basis of many applications and is positioned as the basic function of the information management of an organization.

The content management aims to share information which is generated, is used in enterprises and organizations in real time, and also to enable others to re-use it.

In many systems, a mechanism for each user registering contents or a mechanism for classifying contents is prepared to promote the sharing/re-use of information.

Such re-use is also valuable for an individual. Usually attaching a book mark to important information can prevent a problem that information read before cannot be located, a problem that such information cannot be even remembered, a problem that such information must be read again or the like from occurring, thereby greatly improving productivity.

A recommendation system for selecting contents suitable for a specific user from registered contents is also conventionally known. As such a recommendation system, for example, a content selecting method by collaborative filtering is proposed (for example, see Non-patent reference 4).

Non-Patent Reference 4:

“Topics on Artificial Intelligence: Collaborative Filtering”, [online], National Institute of Informatics-Academic Society Home Village—The Japanese Society for Artificial Intelligence-What's AI-Topics on Artificial Intelligence-Collaborative Filtering, [retrieved Jun. 5, 2003], Internet<URL:http://www.ai-gakkai.or.jp/jsai/whatsai/AItopics2.html>

However, the conventional system has the following problems in the job of the “registration of contents”.
Even when registration work is a little complicated and troublesome, it disturbs usual work. Particularly, in creating work, inserting other complicated and troublesome work in it causes a user to suspend it and it sometimes take several tens of minutes or several hours to restore it. Furthermore, if registration work is complicated and troublesome, a registration process itself takes much time.
For the above-mentioned reason, complex registration work is avoided by a user and becomes obsolete. In the content management system, such inaccessibility in registering contents prevents users to share knowledge.
Sometimes the registration method of information is provided for each tool. However, in this case, since the method is different for each tool, a user must master how to register each time. Since information cannot be collectively managed, a retrieval method is also different for each tool when searching for information. Furthermore, if a separate terminal device is prepared for each tool, hardware costs increase.
There is also an approach of keeping a log in a computer. However, in this case, the storage space of a log becomes enormous, and a user's labor for searching for the log and obtaining information remarkably increases. Furthermore, if a user must operate a plurality of tools, a log cannot be kept for some tools or the format of log is different for each tool. Therefore, this approach does not work.

### SUMMARY OF THE INVENTION

It is an object of the present invention to provide an information registration device for simplifying the registration work of contents re-used in a content management system or the like and a method thereof.

The information registration device in the first aspect of the present invention comprises a display unit and a registration unit. The display unit displays a screen including a common registration area for registering a plurality of types of different information as unclassified information which is not classified for each category. The registration unit registers specified information as unclassified information when a user performs an operation of specifying arbitrary information on the screen and registering the information in the registration area. For example, the display and registration units correspond to the information registration unit 111 shown in FIG. 1, which is described later.

The information registration device in the second aspect of the present invention further comprises an access unit. The access unit accesses a plurality of types of information registered as unclassified information in timing different from the process of the registration unit. The display unit displays a reading screen for unclassified information, and the access unit classifies the unclassified information for each category according to an instruction of a user. For example, the access unit corresponds to the information access unit 112 in FIG. 1, which is described later.

The information management device in the third aspect of the present invention comprises a first storage unit, a second storage unit and a management unit. The first storage unit stores information classified for each category, and the second storage unit collectively stores a plurality of types of different information as information not classified for each category. The management unit stores specified information in the second storage unit when a user performs an operation of specifying arbitrary information on the screen and registering the information in a common registration area for unclassified information. For example, the first storage unit, second storage unit and management unit correspond to the ordinary content storage unit 123, buffer content storage unit 124 and content management unit 122, respectively.

### BRIEF DESCRIPTION OF THE DRAWINGS

FIG. 1 shows the configuration of the first content management system.

FIG. 2 shows the data structure of registered information.

FIG. 3 shows the registration screen.

FIG. 4 shows the first reading screen.

FIG. 5 is the flowchart of the information registration process.

FIG. 6 is the flowchart of the information access process.

FIG. 7 shows the second reading screen.

FIG. 8 shows the configuration of the second content management system.

FIG. 9 shows the configuration of the Internet service system.

FIG. 10 shows the configuration of the information processing device.

FIG. 11 shows recording media.

### DESCRIPTION OF THE PREFERRED EMBODIMENTS

The preferred embodiments of the present invention are described in detail below with reference to the drawings.

In the preferred embodiment, the registration work of contents is performed by one action and is simplified, and also a tool for classifying contents completely independently of the registration work is separately provided. The major features of the system on the preferred embodiment are as follows.

(1) A user can register an arbitrary thing such as an icon and the like, which can be seen through the user interface of a user terminal, or an arbitrary object such as a file/text expressed via the thing, a resource on the Internet and the like, on a display screen using the information registration unit which operates in the user terminal. The registration operation for each thing is realized by only a single action, such as drag-and-drop or the like, and no other interaction is needed when registering it.

(2) The information access unit has a function to read contents registered by the information registration unit, a function to classify them and a function to read the classified result. The information access unit is activated in arbitrary timing independent of that of registration and can collectively handle all pieces or a part of pieces of information registered in an arbitrary period.

(3) The content management system collectively manages unclassified registered contents separately from classified contents, and provides a user with a function to access the unclassified contents in order of meta information, such as titles, and registration times and a function to extract information.

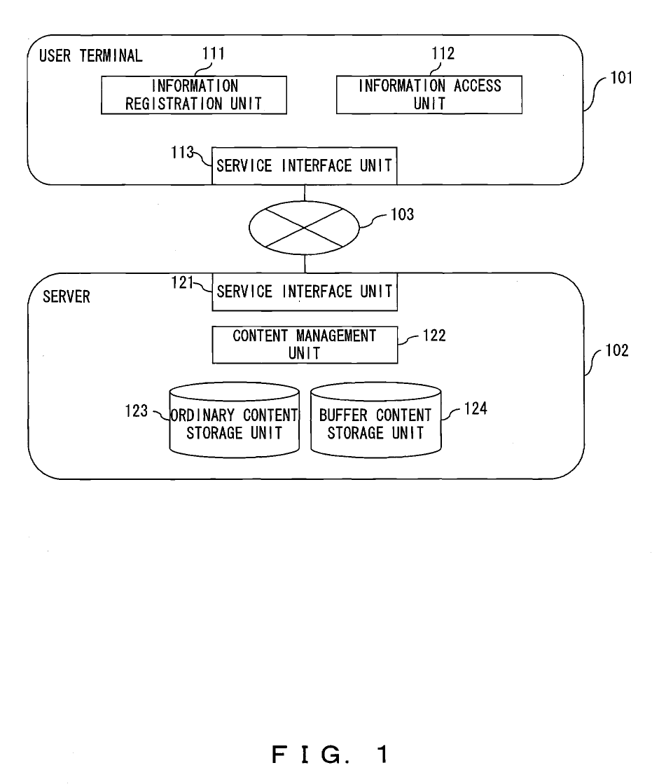

FIG. 1 shows the configuration of the content management system adopting the present invention. The content management system shown in FIG. 1 comprises a user terminal (client) 101, a server 102 and a communication network 103. The user terminal 101 comprises an information registration unit 111, an information access unit 112 and a service interface unit 113. The server 102 comprises a service interface unit 121, a content management unit 122, an ordinary content storage unit 123 and a buffer content storage unit 124.

The user terminal 101 communicates with the server 102 using the service interface unit 113. The server 102 communicates with the user terminal 101 using the service interface unit 121.

The content management unit 122 of the server 102 generally manages a plurality of pieces of information transmitted from a plurality of user terminals 101 collectively as registered information. The registered information classified for each category is stored in the ordinary content storage unit 123, and unclassified registered information is in the buffer content storage 124. The content management unit 122 also has a user authentication function and an index function.

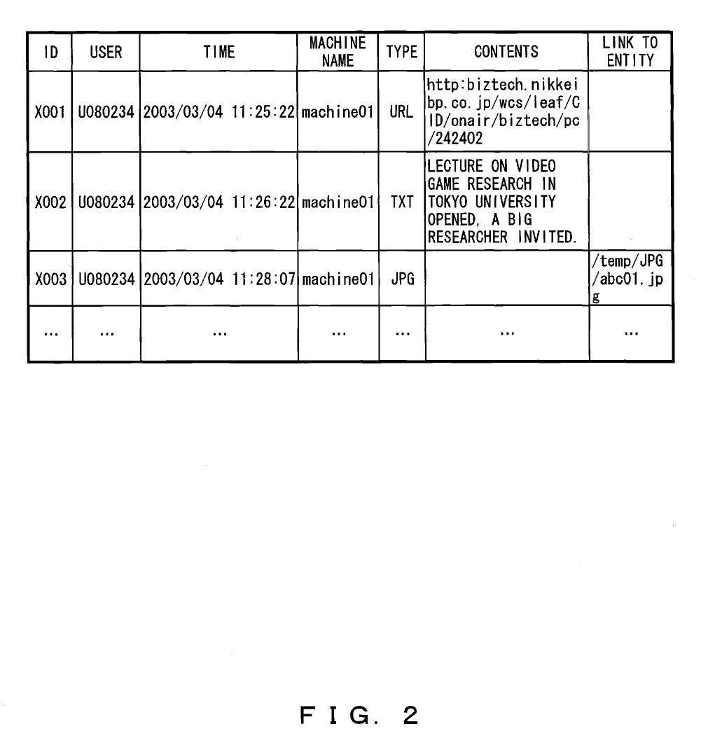

FIG. 2 shows an example of the data structure of registered information stored in the buffer content storage unit 124. In this example, the buffer content storage unit 124 stores the identifier (ID) of registered information, the identifier of a user which registers information, the registration time, the identifier (machine name) of a user terminal 101 which registers information, the type of registered information (data format), meta information of the contents of registered information and a link to the entity of registered information.

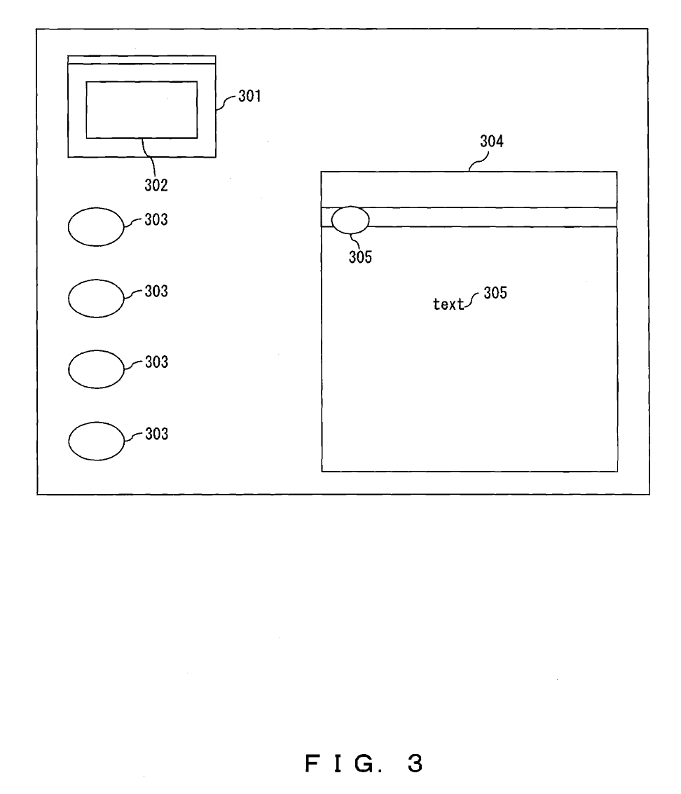

The information registration unit 111 of the user terminal 101 displays a registration screen (registration window) 301 as shown in FIG. 3 and registers information in the server 102. In the registration window 301, a registration panel 302 is provided, and a message “Please drop here” is displayed on the panel.

Each icon 303 other than the registration window 301 and a screen object 305, such as a uniform resource locator (URL) expressed by a tool, such as an Internet browser 304, etc., a text, a file icon, and the like, are information to be registered.

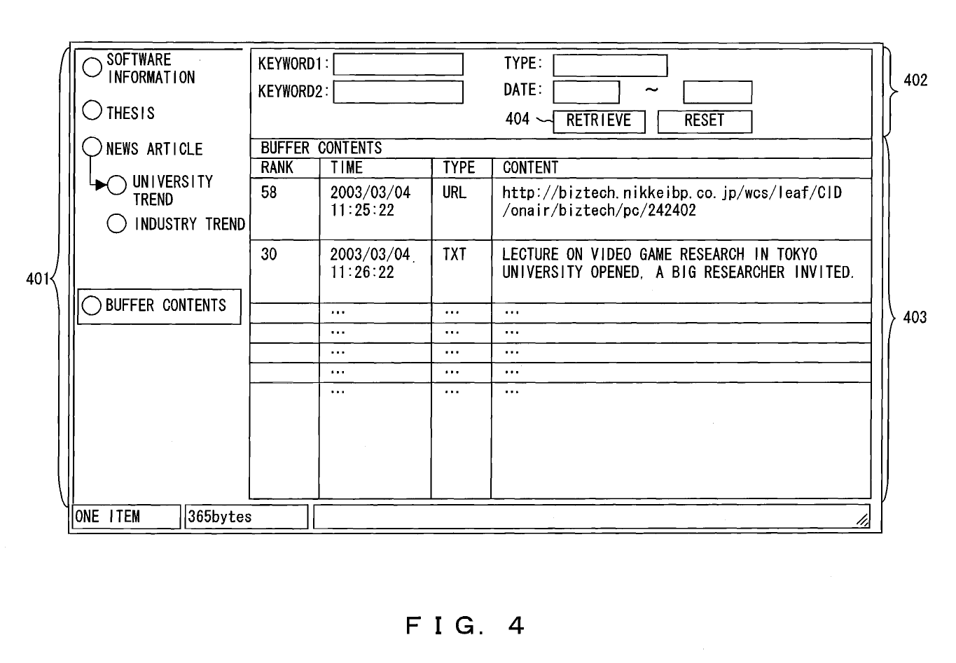

The information access unit 112 displays a reading screen as shown in FIG. 4, and prepares for reading/classifying information registered in the server 102. The reading screen shown in FIG. 4 comprises a category area 401, a retrieval area 402 and a registered information area 403. A user can access registered information on this screen, classify a plurality of pieces of registered information for each category or delete unnecessary information.

In the category area 401, a directory type category system is displayed, and “buffer contents” indicate unclassified information stored in the buffer content storage unit 124. A category system using the category classification of a bookmark or category classification based on a file type can also be displayed in the category area 401.

In the registered information area 403, the registered information in a category selected in the category area 401 is displayed. In this case, the registered information of “buffer contents” is displayed.

In the retrieval area 402, a retrieval condition input box, for inputting a keyword, a type, date and the like, is displayed. If a user inputs desired retrieval conditions and clicks a retrieval button 404, registered information, which meets the conditions, is displayed in the registered information area 403.

Although in FIG. 1, the content management unit 122, the ordinary content storage unit 123 and buffer content storage unit 124 are provided in the server 102, they can also be provided in the user terminal 101. In this case, the content management unit 122 can also manage both the registered information of a single user and that of a plurality of users.

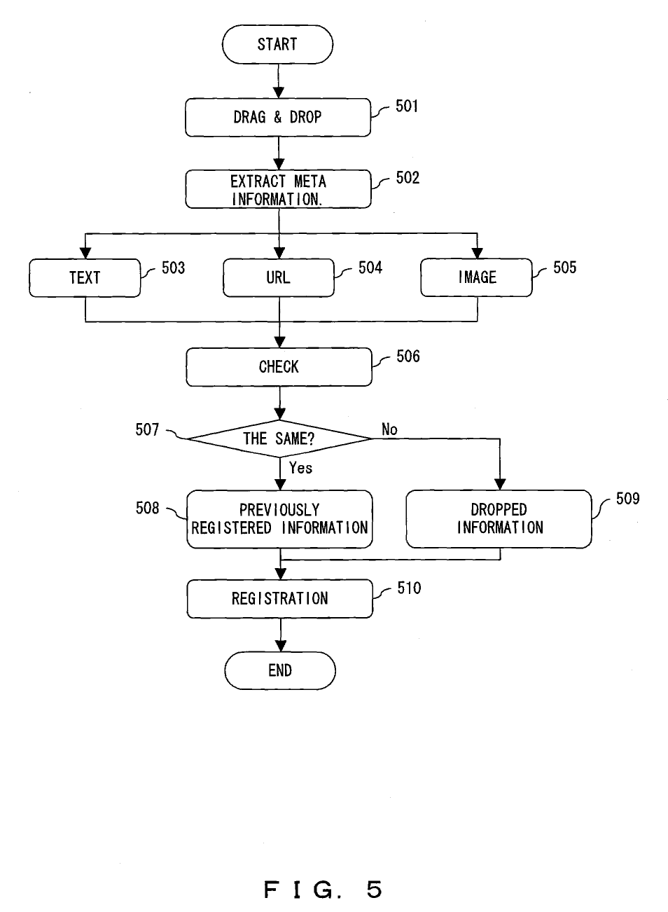

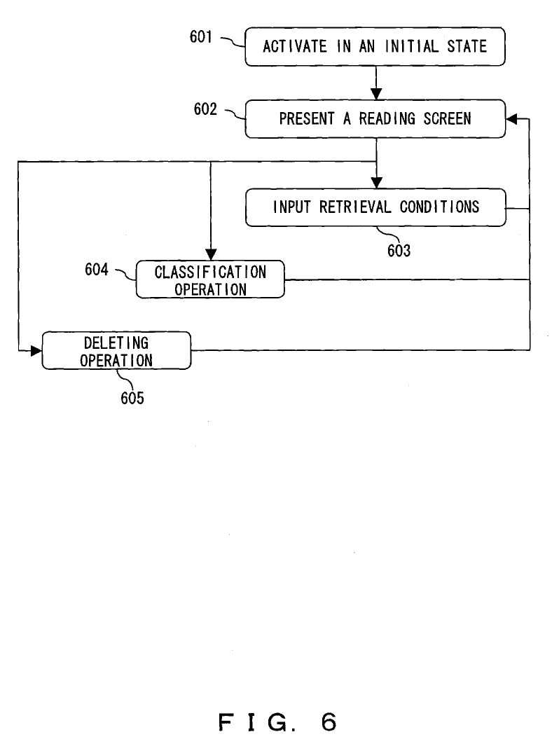

Next, the operation of the content management system shown in FIG. 1 is described in detail with reference to FIGS. 5 and 6.

FIG. 5 is a flowchart showing the information registration process of the information registration unit 111. A user can register a URL, file, text or the like, in arbitrary timing. The information registration unit 111 supports a registration operation utilizing an information transmission means between applications prepared by the operating system of a computer, such as drag-and-drop, cut-and-paste and the like. The information registration process is described below, using drag-and-drop as an example.

On the screen of the user terminal 101, as shown in FIG. 3, the panel 302, to which drag-and-drop is applied, is displayed. A user operates an arbitrary object 305, such as the URL or text of a page that the user currently accessing on the Internet browser 304, a file in a local disk or the like, or an icon 303 using a mouse and inputs it to the panel 302 by drag-and drop (step 501).

The information registration unit 111 extracts meta information (attribute information) from the contents of the dropped information, using a profile extraction tool according to the data type of the dropped information (step 502).

For example, in the case of text, a keyword is extracted, and the obtained keyword is used as attribute information (step 503). In the case of address information such as a URL, a keyword is extracted by analyzing a document pointed to by the information and is used as attribute information (step 504). In the case of image information, the number of colors, the number of vertical and horizontal pixels and the like, are extracted and are used as attribute information (step 505).

Then, the extracted meta information is transmitted to the server 102 to ask the content management unit 122 to check it (step 506). The content management unit 122 checks whether the dropped information coincides with previously registered information, by comparing the received meta information with meta information of the previously registered information, and returns the check result (step 507). If the two pieces of meta information are matched, it is determined that the dropped information coincides with the previously registered information.

If the dropped information coincides with one of a plurality of pieces of the previously registered information, the information registration unit 111 handles the entity of the previously registered information as a registration target instead of handling the registration operation as an error (step 508). Therefore, when the same information is attempted to be registered twice, an inquiry message such as “Overwrite?” is not displayed and waiting for user's input never occurs.

If the dropped information coincides with no previously registered information, the entity of the dropped information is handled as a registration target (step 509). In this case, if the entity of the dropped information exists in the user terminal 101, it is transferred (copied) to the server 102.

Then, the identifier of a user who has performed the registration operation, the registration time, the machine name of the user terminal 101, the type of the registration target, the extracted meta information and a link to the entity of the registration target are transferred to the server 102 (step 510) Then, the content management unit 122 of the server 102 stores the received information in the buffer content storage unit 124.

In step 510, a confirmation message, such as “Registered” or the like, can be displayed on the registration window 301. Alternatively, in step 501, when the user puts the object on the panel 302 in order to drop the information, hint information for suggesting where the object should be registered can be displayed.

However, no error indication causing user's interaction (such as clicking an OK button, etc.) if the dropped information could not be registered is made. Therefore, it seems to the user as if the registration work were completed by one action of drag-and-drop.

FIG. 6 is a flowchart showing the information access process of the information access unit 112. When activated in its initial state (step 601), the information access unit 112 firstly displays a reading screen as shown in FIG. 4 (step 602). The unclassified information registered in “buffer contents” is basically arrayed in order of registration time and in addition is arrayed in such a way that the meta information such as types and contents of the information, and the like can be read as a list.

If a user wants to access individual information, it can also be accessed in this unclassified state. As an access method to the unclassified information, a retrieval function using the retrieval area 402 and a browsing function using the registered information area 403 are provided.

If the user inputs retrieval conditions to the retrieval area 402 and clicks the retrieval button 404 (step 603), a reading screen containing registered information that meets the inputted conditions as its retrieval result is displayed (step 602).

If the user selects information necessary for contents management from a plurality of pieces of unclassified information displayed in the registered information area 403 and classifies it into one of the categories in the category area 401 (step 604), a reading screen for classified information is displayed (step 602).

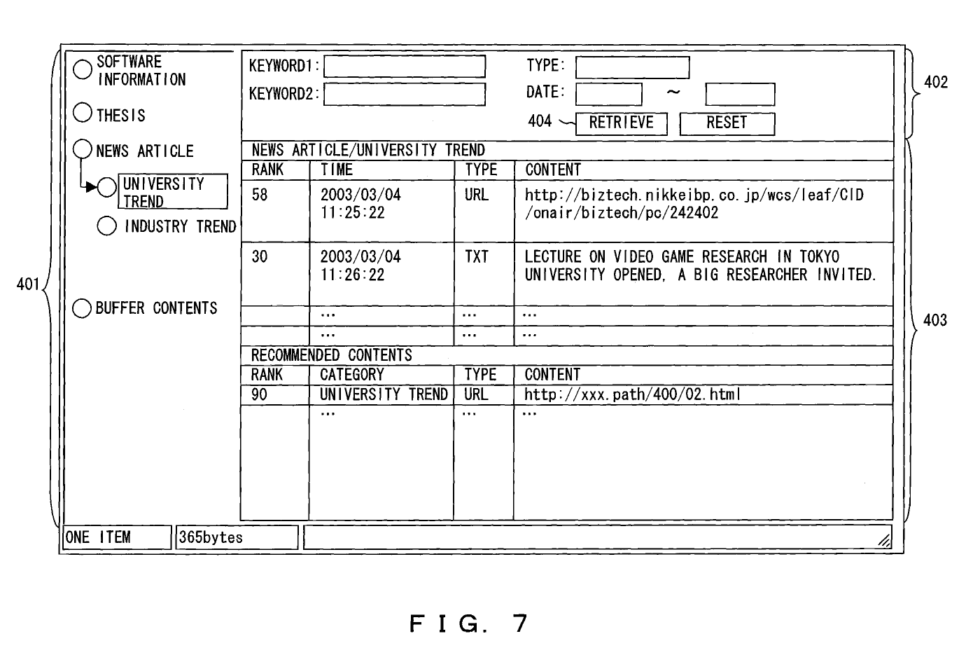

For example, if in FIG. 4 a part of information registered in the “buffer contents” is classified into the category of “news article/university trend”, a reading screen as shown in FIG. 7 is displayed. The “recommended contents” in the registered information area 403 shown in FIG. 7 is described later.

If the user selects unnecessary information from the unclassified information displayed in the registered information area 403 and deletes it (step 605), a reading screen not containing the information is displayed (step 602).

As described above, the user can systemize registered information more or modify its format to one easier to re-use, using the information access unit 112.

In the above-mentioned content management system, when registering information in the server 102, the complexity of a registration procedure can be reduced, and the registration work of information can be separated from its classification work.

Thus, information can be registered in such a way that a user's need for later re-use of information can be met. Therefore, the productivity of work using contents and the efficiency of information acquisition can be both realized simultaneously.

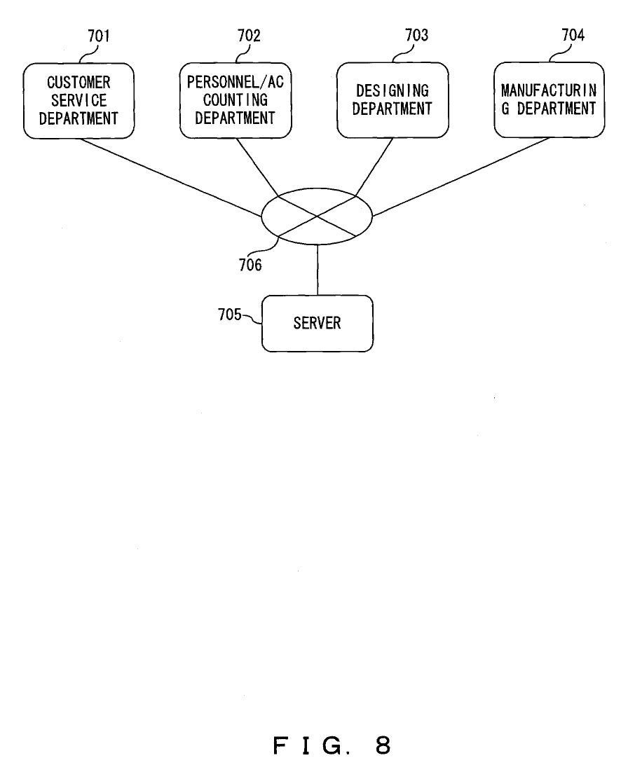

FIG. 8 shows an example of the configuration of the content management system shown in FIG. 1, which is applied to intra-enterprise information management. The terminals, 701, 702, 703 and 704, shown in FIG. 8 correspond to terminals in the customer service department, personnel/accounting department, designing department and manufacturing department, respectively. A server 705 corresponds to the server 102 shown in FIG. 1. Each terminal communicates with the server 705 via an intranet 706. Each terminal registers the information of each department in the server 705 or uses the registered information.

Next, a case where the present invention is applied to analysis utilizing user information or a recommendation system is described.

As such a system, a system for analyzing the features of a user or an organization, the features of contents to be handled or the like, using information about the behavior history of a user, obtained via information registration by the user and utilizing the result can be considered. In this case, the above-mentioned basic procedure of a user registering and utilizing information can be applied without any modification, and in addition to it, an additional function, such as analysis or the like, can also be provided.

A recommendation system to which the present invention is applied, for providing information suitable for a user, based on the user's behavior history is described below.

As such a recommendation system, there is the earlier-mentioned collaborative filtering disclosed by Non-patent reference 4. In this example, when recommending contents to a specific user, the system obtains contents previously registered by a plurality of users, the frequencies of accesses to the registered contents and the like, and recommends contents not yet accessed by the specific user among contents accessed by others whose access tendency is similar to that of the specific user.

Even when a recommendation system is provided as a multi-user service or is provided by combining it with a content management system in a closed environment within a company, each user can promote registration and re-use of contents utilizing results of information registration by the user or others.

(1) Ranking Based on the Degree of Use of Contents

In the following example, when reading information by using the information access unit 112, a user reads the list of “buffer contents” shown in FIG. 4 or the contents classified for each category (“news article/university trend”) shown in FIG. 7. In this case, evaluation scores attached to each content by a recommendation system are displayed in the field “rank” of the registered information area 403. These evaluation scores are calculated according to evaluation criteria, such as ‘A content registered by a lot of people has a high score’, ‘A content frequently used by the user has a high score and a content used by the user more frequently than by others has a high score’ or the like.

The user can sort registered contents in ranking order, for example, by clicking a word “rank” in the registered information area 403 or the like. As a result, since a news article with a high rank is displayed with priority, the user can rapidly access an article which is used by a lot of people, frequently used by the user or is useful to the user since it is frequently used by the user.

(2) Recommendation of New Information for Supplementing a List

Particularly, if the concept of collaborative filtering is used, an article which has a high score and is not registered by a user yet among news articles classified into a category “university trend” by others can be recommended to the user. The information displayed as “recommended contents” in the registered information area 403 shown in FIG. 7 corresponds to such an article.

In the above-mentioned recommendation system, particularly, if the use of others' behavior history is taken into consideration, an anonymity problem occurs. In order to cope with this problem, a method for publishing only a URL to others (protecting anonymity against others) as to only published contents (which can be accessed by a URL), a method for displaying only contents accessed by such a number of people that anonymity can be protected as “recommended contents” or the like is used.

A content uploaded from the personal computer of a user is published only if it is classified into and registered in one of the categories, instead of being registered as “buffer contents” and is specified as one that can be published. Otherwise, others are prohibited from accessing it.

Thus, the sharing of contents important for the mass can be promoted and the leak of private information can be prevented while protecting anonymity. At an individual level, the collective management of information and the acquisition of globally useful information can be simultaneously realized.

As described above, according to the present invention, the following effects can be obtained.

Since registration work is a simple single action, an arbitrary object can be registered on a screen, no accompanying instructions, such as an error, an inquiry and the like, are required, a user's registration operation becomes very simple and information can be easily registered in arbitrary timing. Accordingly, the speed of an information registration process can be improved, thereby promoting the registration of information by a user.

The productivity of work using contents and the acquisition efficiency of information can be both realized simultaneously by separating registration work from classification work.

Particularly, even when the same information is repeatedly registered, the information can be used in the future to present additional information, such as registration tendency or the like, by handling it as an “object frequently registered” instead of indicating it as an error when registering it. This additional information can also be used for ranking in a recommendation system.

Since a common information registration method can be applied to a different tool and a registered object can be accessed based on a registration time, a variety of objects across a plurality of tools related to the work can be collectively and easily handled. Accordingly, there is no need to prepare a different user terminal for each tool, thereby reducing the amount of hardware used to register information.

Next, the preferred embodiments of a service using the present invention are described. The information registration method of the present invention can be effectively implemented in the form of a service on the Internet.

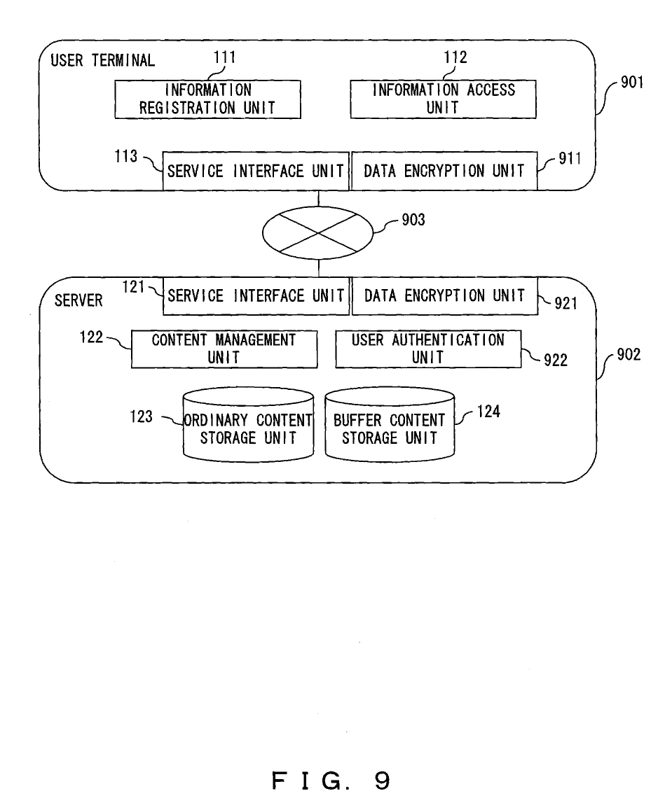

FIG. 9 shows the configuration of such an Internet service system. The service system shown in FIG. 9 comprises a user terminal 901, a server 902 and an Internet 903. The user terminal 901 can be obtained by adding a data encryption unit 911 to the user terminal 101 shown in FIG. 1. The server 902 can be obtained by adding a data encryption unit 921 and a user authentication unit 922 to the server 102 shown in FIG. 1.

The data encryption units 911 and 921 encrypt data in order to ensure security and privacy on the Internet 903. The user authentication unit 922 authenticates a user according to procedures specified by a service provider.

In this case, the content management unit 122 applies distinguished content management to each of a lot of users and stores buffer contents for each user. Even when a user uses the service in a plurality of environments (such as a company, home, etc.) or from a plurality of computers, the user can access contents stored in the server for each user in the same manner. Accordingly, the user can register and access the information at an arbitrary time in an arbitrary place.

If a user uses a service system, the user is required to present a user name and a password when activating the information registration unit 111 and information access unit 112, and the user is allowed to use the tools only after completing the user authentication. After the user is allowed to use the tools, the user registers and accesses information using the information registration unit 111 and information access unit 112.

In the following example, a user checks industry trend in a company using the information registration unit 111. The user checks a news article or the like using an ordinary Internet browser or the like, and consecutively inputs interesting articles to the panel 302 shown in FIG. 3 by drag-and-drop. The user also notices an e-mail which is previously received and stored in the user's personal computer or the like, and also inputs such information. Furthermore, the user also sequentially inputs a thesis which happen to be found, information about software used in the industry and the like, by drag-and-drop without distinguishing them.

By the drag-and-drop, the information registration process shown in FIG. 5 is performed. The processes shown in FIG. 5 other than the process in step 501 are performed in the background of the user terminal 901, and the operability of a user using the user terminal is not damaged.

Even when the user goes home in the middle of work, it is OK if the user terminates the tool as requested without performing a special process.

Then, after being back home, the user starts to classify the information using the information access unit 112 at home.

Firstly, the user checks a news article scored 58 in the “buffer contents” shown in FIG. 4. In this case, when left-clicking a corresponding entry (line) in the “buffer contents” using a mouse (however, the mouse operation varies depending on the system), the ordinary Internet browser is called up and the registered article is displayed.

Then, the user reads the display result and drags-and-drops the entry to a folder “university trend” in the category area 401. The folder of the category area 401 represents the content management unit 122, and as a result of the drag-and-drop, data corresponding to the entry is copied to “university trend” (corresponding to the bookmark of a browser). In this case, in the server 902, data stored in the buffer content storage unit 124 is copied to the ordinary content storage unit 123.

In this way, so that such a background process may not damage user's operability, the process in the user terminal 901 is performed simultaneously with the operation, and the process in the server 902 is performed independently of and in parallel with the process of the user terminal 901.

Similarly, the user classifies a variety of contents, such as e-mail, an image, text and the like. The content registered from the company by e-mail can also be classified by reading the content since its entity is stored in the server 902.

Furthermore, the thesis noticed and registered together while checking news articles can be registered in a folder “thesis”. In this way, since other types of content noticed, while checking the industry trend, are also registered without suspending current work and are finally neatly classified, no chance exists of information being missed.

Although in FIG. 9, the content management unit 122, ordinary content storage unit 123, buffer content storage unit 124 and user authentication unit 922 are provided in the server 902, these units can also be provided in the user terminal 901.

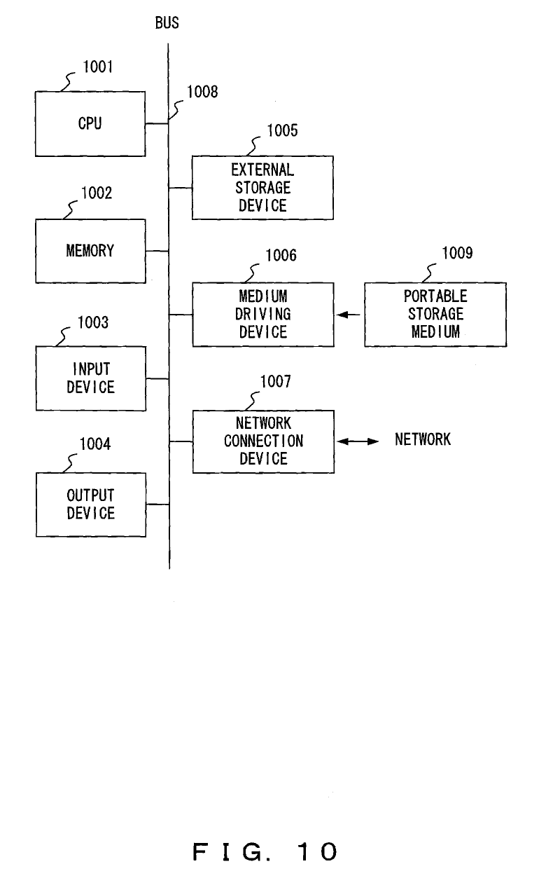

The user terminal 101 and server 102 which are shown in FIG. 1 and the user terminal 901 and server 902 which are shown in FIG. 9 can be configured using the information processing device (computer) as shown in FIG. 10. The information processing device shown in FIG. 10 comprises a central processing unit (CPU) 1001, memory 1002, an input device 1003, an output device 1004, an external storage device 1005, a medium driving device 1006 and a network connection device 1007, which are connected to each other by a bus 1008.

The memory 1002 includes read-only memory (ROM), random-access memory (RAM) and the like, and stores a program and data to be used for the process. The CPU 1001 performs necessary processes by using the memory 1002 and executing the program.

The information registration unit 111, information 112, service interface units 113 and 121, content management unit 122, data encryption units 911 and 921 and user authentication unit 922 shown in FIG. 1 or 9 correspond to the program stored in the memory 1002.

The input device 1003 includes a keyboard, a pointing device (such as a mouse), a touch panel and the like, and is used for an operator (a user or a manager) to input instructions and information. The output device 1004 includes a display, a printer, a speaker and the like, and is used to output inquiries and process results to the operator.

The external storage device 1005 includes a magnetic disk device, an optical disk device, a magneto-optical disk device, a tape device and the like. The information processing device stores the program and data in the external storage device 1005, and uses them by loading them onto the memory 1002, as requested. The external storage device 1005 is also used as the ordinary content storage unit 123 and buffer content storage unit 124 which are shown in FIGS. 1 and 9.

The medium driving device 1006 drives a portable storage medium 1009 and accesses its recorded contents. The portable storage medium 1009 is an arbitrary computer-readable storage medium, such as a memory card, a flexible disk, compact disk read-only memory (CD-ROM), an optical disk, a magneto-optical disk or the like. The operator stores the program and data in this portable storage medium 1009, and uses them by loading them onto the memory 1002, as requested.

The network connection device 1007 is connected to an arbitrary communication network, such as a local area network (LAN), the Internet or the like, and converts data accompanying communication. The information processing device receives the program and data from an external device via the network connection device 1007, and uses them by loading them onto the memory 1002, as requested.

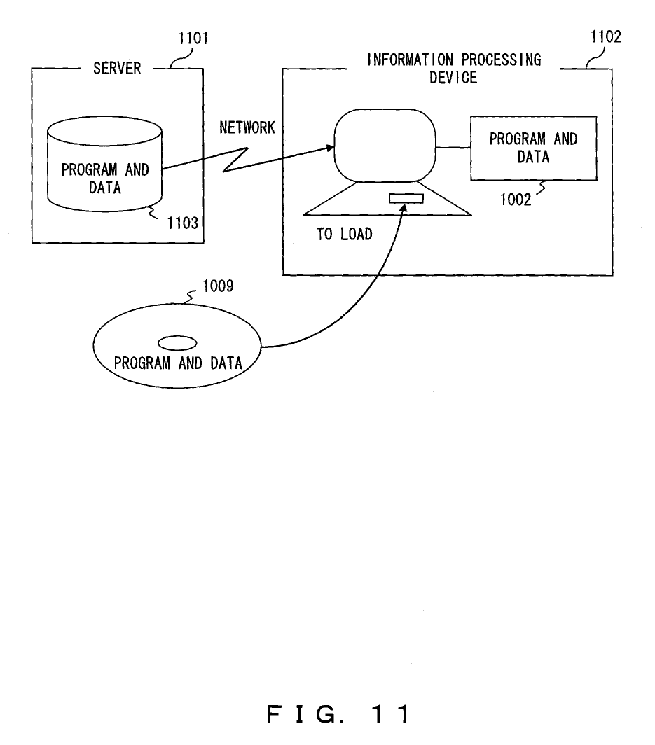

FIG. 11 shows computer-readable storage media capable of supplying the information processing device shown in FIG. 10 with the program and data. The program and data stored in the portable storage medium 1009 or the database 1103 of the server 1101 is loaded onto the memory 1002 of the information processing device 1102. The server 1101 generates a propagation signal for propagating the program and data, and transmits it to the information processing device 1102 via an arbitrary transmission medium in the network. The CPU 1001 performs necessary processes by using the data and executing the program.

What is claimed is:

1. An information registration device, comprising:
a display unit displaying a screen including a common registration area for registering a plurality of types of different information as unclassified information not classified for each category; and
a registration unit registering specified information as the unclassified information when a user performs an operation of specifying arbitrary information on the screen and registering the information in the registration area.

2. The information registration device according to claim 1, further comprising
an access unit accessing the plurality of types of information registered as the unclassified information in timing different from a process of said registration unit, wherein
said display unit displays a reading screen of the unclassified information, and the access unit classifies the unclassified information for each category, according to a user's instruction.

3. The information registration device according to claim 1, further comprising:
a first storage unit storing information classified for each category;
a second storage unit collectively storing the unclassified information; and
a management unit storing the specified information in the second storage unit.

4. A computer-readable storage medium on which is recorded a program for enabling a computer to execute a process, the process comprising:
displaying a screen including a common registration area for registering a plurality of types of different information as unclassified information not classified for each category; and
registering specified information as the unclassified information when a user performs an operation of specifying arbitrary information on the screen and registering the information in the registration area.

5. The storage medium according to claim 4, wherein
the computer registers screen objects including an icon, an Internet address, a text and a file on the screen as the unclassified information.

6. The storage medium according to claim 4, wherein
when the specified information coincides with already registered information, the computer accepts the specified information by handling the already registered information as an entity and outputs no inquiry message to the user.

7. The storage medium according to claim 4, wherein
even when the specified information could not be registered, the computer performs no error indication accompanying an interaction with the user.

8. The storage medium according to claim 4, the process further comprising:
accessing the plurality of types of information registered as the unclassified information in timing different from the registering the specified information;
displaying a reading screen of the unclassified information; and
classifying the unclassified information for each category, according to a user' instruction.

9. A computer-readable storage medium on which is recorded a program for enabling a computer to execute a process, the process comprising:
storing arbitrary information in a first storage unit storing information classified for each category, when a user performs an operation of specifying a category and registering the information; and
storing specified information in a second storage unit collectively storing unclassified information not classified for each category when a user performs an operation of specifying arbitrary information and registering the information in a common registration area for registering a plurality of types of different information as the unclassified information.

10. The storage medium according to claim 9, the process further comprising:
evaluating the plurality of types of information registered as the unclassified information in the second storage unit according to an evaluation criterion based on a behavior history of each user; and
selecting information suitable for a specific user from the evaluated unclassified information and providing the information.
